(19) United States
(12) Patent Application Publication
(10) Pub. No.: US 2008/0317502 A1
(43) Pub. Date: Dec. 25, 2008

(54) IMAGE FORMING APPARATUS AND IMAGE FORMING METHOD USING LATENT IMAGES

(75) Inventors: Ji-won JEONG, Suwon-si (KR); Cheol-ho JEONG, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/125,951

(22) Filed: May 23, 2008

(30) Foreign Application Priority Data
Jun. 20, 2007 (KR) 10-2007-0060681

(51) Int. Cl. G03G 15/22

(52) U.S. Cl. 399/130

(57) ABSTRACT

An image forming apparatus and an image forming method are provided, in which a drum itself forms an electrostatic latent image for each of one or more basic colors in accordance with print data on a surface of the drum while making the polarities of the electrostatic latent images different, the electrostatic latent images are developed so as to generate developed images, the developed images are transferred onto a printing medium, and the transferred images are fixed to the printing medium. Accordingly, color printing can be rapidly completed even by using a number of drums less than the number of basic colors for use in representing colors to be printed, it is possible to reduce the size of an image forming apparatus, and high quality print outs can be obtained.

### CROSS-REFERENCE TO RELATED PATENT APPLICATION

This application claims the benefit of Korean Patent Application No. 10-2007-0060681, filed on Jun. 20, 2007, in the Korean Intellectual Property Office, the disclosure of which is incorporated herein in its entirety by reference.

### BACKGROUND OF THE INVENTION

1. Field of the Invention

The present invention relates to printing, and more particularly to an image forming apparatus and an image forming method in which color printing is performed.

2. Description of the Related Art

Conventional image forming apparatuses create print outs by performing different exposing processes, based on data that is to be printed, with respect to a drum surface uniformly charged with a certain polarity to form an electrostatic latent image on the drum surface, developing the electrostatic latent image using a developer such as a toner to form a developed image, transferring the developed image onto a printing medium, and fixing the transferred image onto the printing medium.

As such, conventional image forming apparatuses must perform the operation of uniformly charging the entire drum surface and the operation of exposing the drum surface in order to create print outs, and as such there is a limit in reducing the time required for the conventional image forming apparatuses to print data.

Furthermore, conventional image forming apparatuses necessarily include a device for uniformly charging the entire surface of a drum with charges of a certain polarity and a device for exposing the drum surface, and as such there is also a limit in reducing the sizes of image forming apparatus products. Therefore, conventional image forming apparatuses fail to match recent trends in which small products hold a dominant position in the market.

In conventional image forming apparatuses which perform color printing, colors to be printed are represented using a plurality of basic colors.

More specifically, conventional image forming apparatuses which perform color printing have a single drum, and can perform color printing in a principle where only after a charging operation, an exposing operation, a developing operation, a transfer operation, and a fixing operation for one basic color are performed on the drum and the surface of the drum is cleaned, a charging operation, an exposing operation, a developing operation, a transfer operation, and a fixing operation for another basic color are performed on the drum. Accordingly, in these conventional image forming apparatuses which perform color printing, as the number of basic colors for use in representing colors to be printed increases, rapid color printing is difficult.

To overcome this problem, conventional image forming apparatuses which perform color printing have a number of drums as many as the number of basic colors for use in representing colors to be printed, and can perform color printing by conducting a charging operation, an exposing operation, a developing operation, a transfer operation, and a fixing operation for each basic color on each corresponding drum. However, as the number of basic colors for use in representing colors to be printed increases, these conventional image forming apparatuses which perform color printing are required to include many drums. Consequently, market competitiveness is reduced due to the enlargement of the sizes of image forming apparatuses and the price increases thereof.

### SUMMARY OF THE INVENTION

Exemplary embodiments of the present invention provide an image forming apparatus which prints data without performing uniform charging over the entire surface of a drum with charges of a certain polarity and without performing exposure with respect to the drum surface and rapidly completes color printing by using a minimum number of drums.

Exemplary embodiments of the present invention also provide an image forming method in which data is printed without performing uniform charging over the entire surface of a drum with charges of a certain polarity and performing exposure with respect to the drum surface and in which color printing is rapidly completed by using a minimum number of drums.

Exemplary embodiments of the present invention also provide a computer readable recording medium having stored thereon a computer program for an image forming method in which data is printed without performing uniform charging over the entire surface of a drum with charges of a certain polarity and performing exposure with respect to the drum surface and in which color printing is rapidly completed by using a minimum number of drums.

According to an aspect of the present invention, there is provided an image forming apparatus which represents color of print data to be printed by using at least one basic color, the image forming apparatus comprising: one or more drums each itself forming an electrostatic latent image for each of the one or more basic colors in accordance with the print data on a surface of the drum while making the polarities of the electrostatic latent images different; a developing unit developing the electrostatic latent images so as to generate developed images; a transfer unit transferring the developed images onto a printing medium; and a fixing unit fixing the transferred images to the printing medium.

According to another aspect of the present invention, there is provided an image forming method performed in an image forming apparatus that represents color of print data to be printed by using at least one basic color and comprises one or more drums, the method comprising: forming an electrostatic latent image for each of the one or more basic colors in accordance with the print data on a surface of the drum while making the polarities of the electrostatic latent images different; developing the electrostatic latent images so as to generate developed images; transferring the developed images onto a printing medium; and fixing the transferred images to the printing medium, wherein the forming of the electrostatic latent image is performed by each of the drums itself.

According to another aspect of the present invention, there is provided a computer readable medium having embodied thereon a computer program for the method comprising: forming an electrostatic latent image for each of the one or more basic colors in accordance with the print data on a surface of the drum while making the polarities of the electrostatic latent images different; developing the electrostatic latent images so as to generate developed images; transferring the developed images onto a printing medium; and fixing the transferred images to the printing medium, wherein the forming of the electrostatic latent image is performed by each of the drums itself.

### BRIEF DESCRIPTION OF THE DRAWINGS

The above and other features and advantages of exemplary embodiments of the present invention will become more apparent by describing in detail exemplary embodiments thereof with reference to the attached drawings in which:

FIG. 1A is a block diagram of an image forming apparatus according to an exemplary embodiment of the present invention;

FIG. 1B is a perspective view of a structure of the image forming apparatus illustrated in FIG. 1A;

FIGS. 2A through 2C are reference diagrams for explaining cells that constitute a circumferential layer of a drum illustrated in FIG. 1B and an electrostatic latent image forming unit illustrated in FIG. 1A; and

FIG. 3 is a flowchart of an image forming method according to an exemplary embodiment of the present invention.

### DETAILED DESCRIPTION OF EXEMPLARY EMBODIMENTS OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the present invention will be described in detail by explaining exemplary embodiments of the invention with reference to the attached drawings. Like reference numerals in the drawings denote like elements.

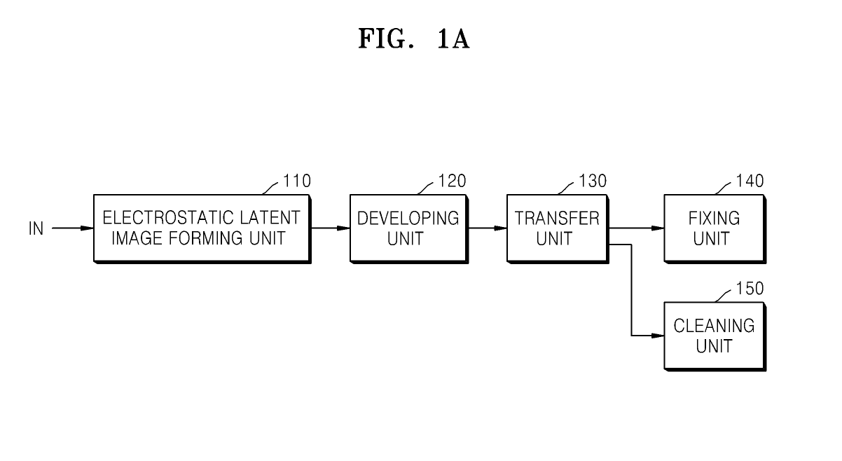

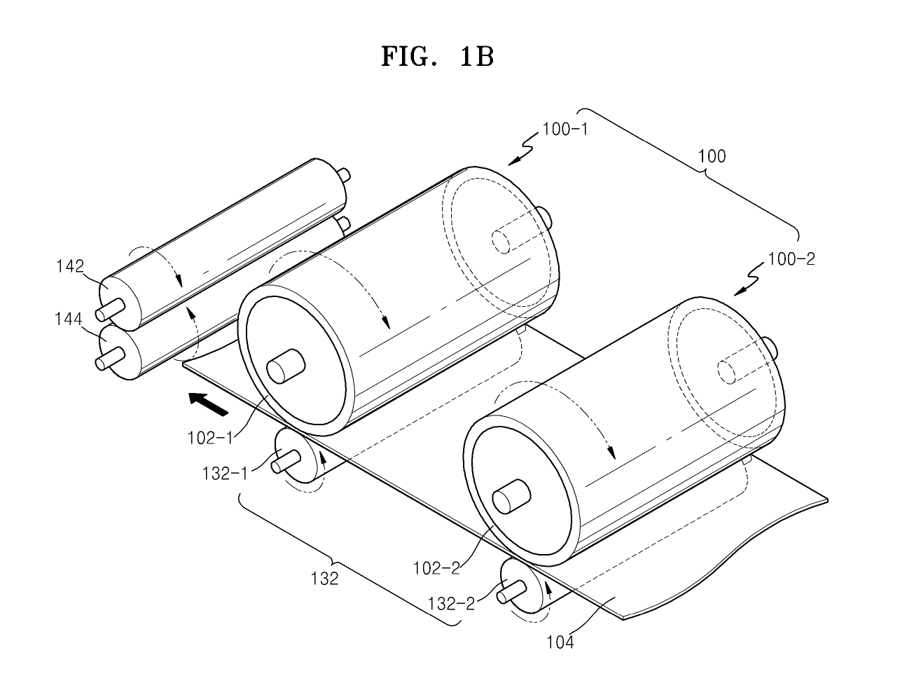

FIG. 1A is a block diagram of an image forming apparatus according to an exemplary embodiment of the present invention, which includes an electrostatic latent image forming unit 110, a developing unit 120, a transfer unit 130, a fixing unit 140, and a cleaning unit 150. FIG. 1B is a perspective view of a structure of the image forming apparatus illustrated in FIG. 1A.

The image forming apparatus in this specification denotes an apparatus having a printing function, such as, a printer or a multifunction peripheral (MFP) having a printing function. In particular, an image forming apparatus according to exemplary embodiments of the present invention denotes an image forming apparatus that can perform color printing. The image forming apparatus according to exemplary embodiments of the present invention performs color printing by representing colors to be printed by using a plurality of basic colors. Hereinafter, for convenience of explanation, it is assumed that the plurality of basic colors are yellow (Y), magenta (M), cyan (C), and black (K).

Referring to FIGS. 1A and 1B, the image forming apparatus according to an exemplary embodiment of the present invention has at least one drum 100. More specifically, the image forming apparatus according to an exemplary embodiment of the present invention has N (where N denotes a natural number) drums 100. Each drum 100-n (where n denotes an integer satisfying 1≦n≦N) is different from a drum, known as a photoconductive drum, included in a conventional image forming apparatus. More specifically, the circumferential layer 102-n of the drum 100-n is made up of a plurality of cells. The entire area of the circumferential layer 102-n is preferably divided into the plurality of cells. In other words, each cell corresponds to a basic unit of the components of the circumferential layer 102-n of the drum 100-n. Hereinafter, for convenience of explanation, it is assumed that the circumferential layer 102-n of the drum 100-n is implemented as a plurality of cells arranged in a matrix. In the present invention, the element “the circumferential layer” 102-n of the drum 100-n denotes not only the surface of the drum 100-n but also includes a space between the surface of the drum 100-n and a certain distance inwards from the surface of the drum 100-n towards the center of the drum 100-n. Here, the value of the certain distance inwards from the surface of the drum 100-n may vary.

Each cell includes a capacitor, which has two plates between which a dielectric material is interposed. One of the two plates of each of the cells of the circumferential layer 102-n of the drum 100-n is a part of the surface of the drum 100-n. The capacitors of the cells which constitute the circumferential layer 102-n of the drum 100-n may be separated from one another so that a charge charged in one capacitor does not affect the charging state of another capacitor. To separate the capacitors of the cells from one another, each of the cells has an insulating portion (hereinafter, referred to as a barrier wall) that surrounds a portion around the two plates of a corresponding capacitor.

The drum 100-n may have a variety of shapes. In other words, the drum 100-n may be a cylindrical drum as shown in FIG. 1B or a belt-shaped drum in contrast to FIG. 1B.

The electrostatic latent image forming unit 110 is implemented as the N drums 100. Hereinafter, for convenience of explanation, N is assumed to be 2.

At least one basic color may be pre-allocated to each of the N drums 100. Hereinafter, for convenience of explanation, it is assumed that two basic colors, namely, Y and M, are allocated to a drum 100-1 and two basic colors, namely, C and K, are allocated to a drum 100-2.

In this case, the drum 100-n itself forms at least one electrostatic latent image corresponding to print data input via an input port IN on the surface thereof. The print data input via the input port IN denotes data that the image forming apparatus desires to print, and also denotes data that can be printed.

More specifically, the drum 100-n itself forms an electrostatic latent image for each of the at least one basic colors on the surface thereof in accordance with print data that the image forming apparatus desires to print. The electrostatic latent images for the basic colors have different polarities. For example, the drum 100-1 itself may form electrostatic latent images for the Y and M colors on the surface thereof while making the electrostatic latent images for the Y and M colors have different polarities. Similarly, the drum 100-2 itself may form electrostatic latent images for the C and K colors on the surface thereof while making the electrostatic latent images for the C and K colors have different polarities. Hereinafter, for convenience of explanation, it is assumed that the drum 100-1 forms an electrostatic latent image for the Y color having a positive polarity and an electrostatic latent image for the M color having a negative polarity and that the drum 100-2 forms an electrostatic latent image for the C color having a positive polarity and an electrostatic latent image for the K color having a negative polarity.

To achieve this, the drum 100-n charges the cells of the circumferential layer 102-n thereof in consideration of the print data that the image forming apparatus desires to print, thereby forming the electrostatic latent image for each of the basic colors on the surface thereof. To be more specific, the drum 100-n forms the electrostatic latent image for each of the basic colors on the surface thereof by updating the polarity of one plate of each of the cells, the plate being a part of the surface of the drum 100-n, in consideration of the print data. For example, the drum 100-1 may charge plates corresponding to a to-be-formed electrostatic latent image among the plates of the cells that are located at the surface of the drum 100-1. If a basic color corresponding to the to-be-formed electrostatic latent image is Y, plates corresponding to the to-be-formed electrostatic latent image may be charged with charges of Q (which is a positive number) Coulombs. If the basic color corresponding to the to-be-formed electrostatic latent image is M, the plates corresponding to the to-be-formed electrostatic latent image may be charged with charges of P (which is a negative number) Coulombs. Similarly, the drum 100-2 may charge plates corresponding to a to-be-formed electrostatic latent image among the plates of the cells that are located at the surface of the drum 100-2. If a basic color corresponding to the to-be-formed electrostatic latent image is C, plates corresponding to the to-be-formed electrostatic latent image may be charged with charges of Q Coulombs. If the basic color corresponding to the to-be-formed electrostatic latent image is K, the plates corresponding to the to-be-formed electrostatic latent image may be charged with charges of P Coulombs.

The drum 100-n operates in consideration of the size (for example, A4 or B5) of a printing medium 104, on which the print data is to be printed. More specifically, the drum 100-n recognizes only cells that are to contact the printing medium 104 during transfer among the cells of the circumferential layer 102-n of the drum 100-n, and charges only the recognized cells in consideration of the print data to thereby form the at least one electrostatic latent image. The printing medium 104 denotes a medium on which an image is to be printed. The printing medium 104 may be formed of various materials, such as, an overhead projector (OHP) film. The size of the printing medium 104 may denote the area of the printing medium 104.

The drum 100-n also operates in consideration of a printing resolution (for example, 1200 dpi (dot per inch)) set for the print data that the image forming apparatus desires to print. For example, whether the plates of the cells that are located at the surface of the drum 100-n are charged with charges of Q Coulombs or with charges of P Coulombs is determined according to a printing resolution set for the print data input via the input port IN even when the input print data is identical.

The developing unit 120 generates a developed image by developing the electrostatic latent image formed by the electrostatic latent image forming unit 110 using a developer. In other words, the developed image denotes a result of the developing of the electrostatic latent image. The developer may be toner.

The developer may have a certain polarity, and the polarity of the developer may depend on the color thereof. More specifically, the polarity of the developer is opposite to that of an electrostatic latent image to be developed by the developer. Hereinafter, for convenience of explanation, it is assumed that a developer with a basic color of Y has a negative polarity, a developer with a basic color of M has a positive polarity, a developer with a basic color of C has a negative polarity, and a developer with a basic color of K has a positive polarity.

The transfer unit 130 transfers the at least one electrostatic latent image generated by the developing unit 120 onto the printing medium 104. The transfer unit 130 may be implemented as N transfer rollers 132. In this case, the at least one electrostatic latent image existing on the surface of the drum 100-n is transferred onto the printing medium 104 by an engagement of a transfer roller 132-n with the drum 100-n. Rotations of the drum 100-n and the transfer roller 132-n may be clockwise and counterclockwise, respectively, as shown in FIG. 1B, or may be counterclockwise and clockwise, respectively, in contrast to FIG. 1B.

The developed image existing on the surface of the drum 100-n may be transferred onto the printing medium 104 wherein a portion of the surface of the drum 100, on which the developed image is located, is charged to correspond to the polarity of the developed image. More specifically, immediately before at least one particle of the developer attached to one of the two plates of each cell, which is a part of the surface of the drum 100-n, is transferred onto the printing medium 104, the polarity of the one plate can be updated to a polarity opposite to the polarity of the developer particle. For example, if the developer particle attached to the one plate of each cell has a negative polarity, the polarity of the one plate may be changed from positive to negative immediately before the developer particle attached to the one plate is transferred onto the printing medium 104. In a conventional image forming apparatus, only a transfer roller is charged to transfer a developed image existing on a drum surface. However, in an image forming apparatus according to exemplary embodiments of the present invention, as illustrated in FIGS. 1A and 1B, the surface of the drum 100-n is charged to detach the developed image therefrom, and the transfer roller 132-n is also charged to transfer the detached developed image onto the printing medium 104. Consequently, the developed image existing on the surface of the drum 100-n according to exemplary embodiments of the present invention is more easily transferred onto the printing medium 104 than the transfer of the developed image existing on the conventional drum surface.

The fixing unit 140 fixes the at least one electrostatic latent image transferred by the transfer unit 130 to the printing medium 104. More specifically, the fixing unit 140 fixes the developed image transferred onto the printing medium 104 to the printing medium 104 using heat and pressure. To achieve the fixing, the fixing unit 140 may be implemented as a heat roller 142 and a pressure roller 144. The heat roller 142 heats the printing medium 104 fed between the heat roller 142 and the pressure roller 144 that engage with each other. The pressure roller 144 presses the printing medium 104 fed between the heat roller 142 and the pressure roller 144 that engage with each other. Rotations of the heat roller 142 and the pressure roller 144 may be clockwise and counterclockwise, respectively, as shown in FIG. 1B, or may be counterclockwise and clockwise, respectively, in contrast to FIG. 1B.

After an operation of the transfer unit 130 with respect to the drum 100-n is completed, the cleaning unit 150 removes particles of the developer remaining on the surface of the drum 100-n. The developer representing the at least one electrostatic latent image existing on the surface of the drum 100-n should be entirely transferred onto the printing medium 104. However, in practice, some of the developer may remain on the surface of the drum 100-n even after the transfer of the developer. Particles of the developer that remain on the surface of the drum 100-n after the transfer unit 130 transfers print data input for a t-th (where t denotes a natural number) time via the input port IN degrade the quality of printing of print data that is input for a (t+1)th time via the input port IN. Therefore, the image forming apparatus of FIGS. 1A and 1B includes the cleaning unit 150 in order to remove the remaining developer particles.

In order to remove the developer particles that remain on the surface of the drum 100-n after the completion of the transfer with respect to the drum 100-n by the transfer unit 130, the cleaning unit 150 may initialize the electrical state of the surface of the drum 100-n. For example, if the polarity of the developer particles remaining on the surface of the drum 100-n after the completion of the transfer with respect to the drum 100-n by the transfer unit 130 is negative and the default polarity of the surface of the drum 100-n is neutral, the polarity of a surface area of the drum 100-n on which the developer particles remain after the completion of the transfer with respect to the drum 100-n by the transfer unit 130 is changed from positive to neutral so that the remaining developer particles are easily detached from the surface of the drum 100. Accordingly, when new print data is given, the image forming apparatus according to exemplary embodiments of the present invention can easily remove remaining developer particles from the drum surface before starting printing the new print data.

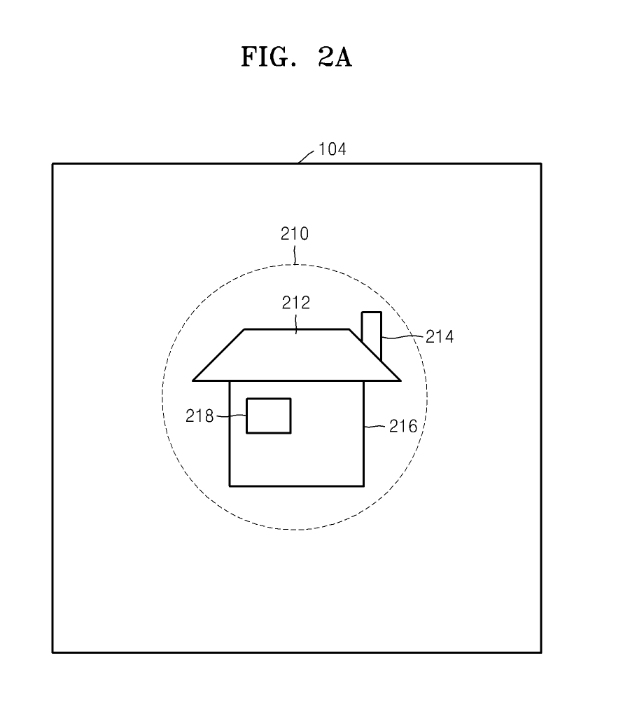

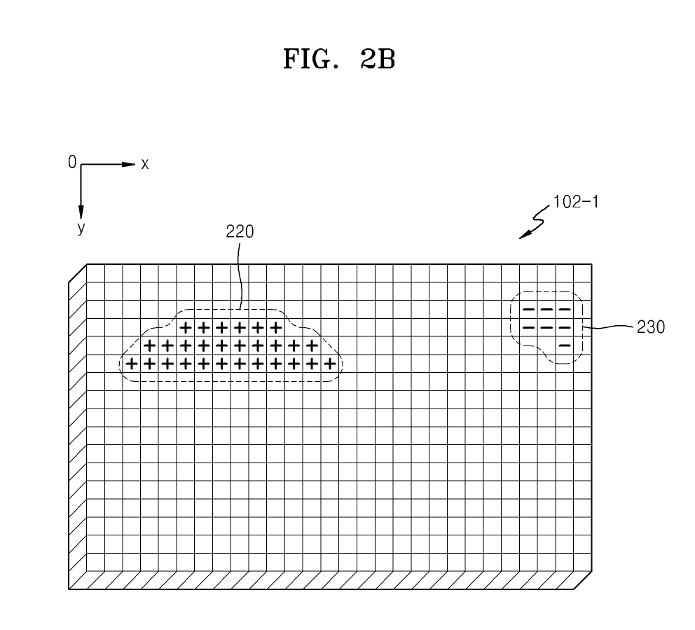

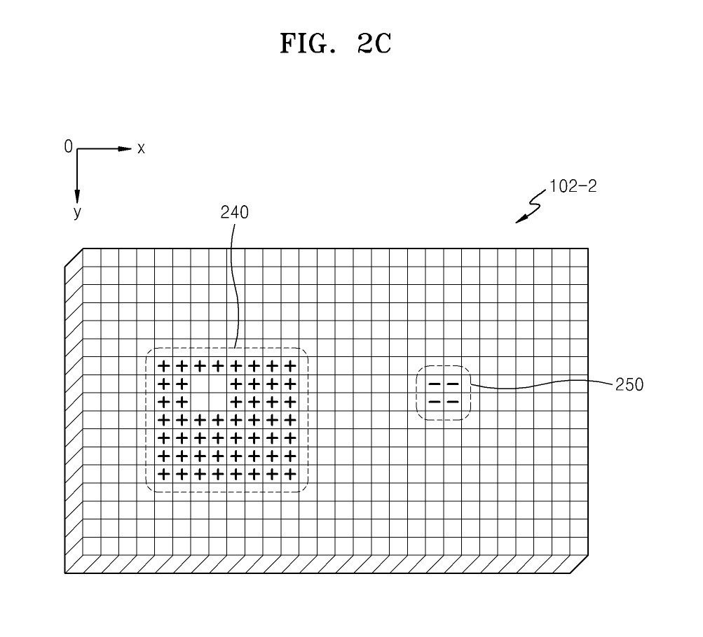

FIGS. 2A through 2C illustrate the cells that constitute the circumferential layer 102 of the drum 100 of FIG. 1B and the electrostatic latent image forming unit 110 of FIG. 1A.

More specifically, FIG. 2A illustrates an image 210 that the image forming apparatus of FIGS. 1A and 1B desires to print on the printing medium 104. The image 210 is a house, which is made up of a roof image 212 of a Y color, a chimney image 214 of an M color, a wall image 216 of a C color, and a window image 218 of a K color.

FIG. 2B illustrates an unrolled circumferential layer 102-1 of the drum 100-1 illustrated in FIG. 1B in order to explain the cells that constitute the circumferential layer 102-1 of the drum 100-1 of FIG. 1B and the electrostatic latent image forming unit 110 of FIG. 1A. Similarly, FIG. 2C illustrates an unrolled circumferential layer 102-2 of the drum 100-2 illustrated in FIG. 1B in order to explain the cells that constitute the circumferential layer 102-2 of the drum 100-2 of FIG. 1B and the electrostatic latent image forming unit 110 of FIG. 1A. As illustrated in FIGS. 2B and 2C, it is assumed that each of the cells includes a capacitor and a barrier wall.

As illustrated in FIGS. 2B and 2C, the circumferential layer 102-n of the drum 100-n may be made up of a plurality of cells that are arranged in a matrix. Referring to FIGS. 2B and 2C, 28 columns of cells exist in a horizontal direction (i.e., an x-axis direction) and 17 rows of cells exist in a vertical direction (i.e., a y-axis direction), such that the circumferential layer 102-n of the drum 100-n is made up of 476 cells (where 476=28×17).

In this case, the drum 100-n forms an electrostatic latent image corresponding to print data for each of the basic colors on a surface thereof by, in consideration of the print data, charging the cells which constitute the circumferential layer 102-n of the drum 100-n. In other words, the drum 100-n charges the 476 cells having 476 locations (x, y), namely, (1, 1), (1, 2), (1, 3), (1, 4), . . . , (28, 15), (28, 16), and (28, 17), in consideration of the print data, thereby forming the electrostatic latent image for each of the basic colors on a surface thereof. Here, a location (x, y), being (I, j) (where i is an integer satisfying 1≦i≦28, and j is an integer satisfying 1≦j≦17), denotes a location with an i-th coordinate in a horizontal direction and a j-th coordinate in a vertical direction.

As illustrated in FIG. 2B, the drum 100-1 forms an electrostatic latent image for each of the two basic colors, namely, Y and M. More specifically, the drum 100-1 itself forms an electrostatic latent image 220 (which has a positive polarity) corresponding to the roof image 212 and an electrostatic latent image 230 (which has a negative polarity) corresponding to the chimney image 214 on the surface thereof. To be further specific, the drum 100-1 itself forms the two electrostatic latent images for the two basic colors, namely, Y and M, by charging plates corresponding to the electrostatic latent image 220 among the plates of the cells corresponding to parts of the surface of the drum 100-1 with charges of Q Coulombs and charging plates corresponding to the electrostatic latent image 230 among the plates of the cells corresponding to parts of the surface of the drum 100-1 with charges of P Coulombs.

Similarly, as illustrated in FIG. 2C, the drum 100-2 forms an electrostatic latent image for each of the two basic colors, namely, C and K. More specifically, the drum 100-2 itself forms an electrostatic latent image 240 (which has a positive polarity) corresponding to the wall image 216 and an electrostatic latent image 250 (which has a negative polarity) corresponding to the window image 218 on the surface thereof. To be further specific, the drum 100-2 itself forms the two electrostatic latent images for the two basic colors, namely, C and K, by charging plates corresponding to the electrostatic latent image 240 among the plates of the cells corresponding to parts of the surface of the drum 100-2 with charges of Q Coulombs and charging plates corresponding to the electrostatic latent image 250 among the plates of the cells corresponding to parts of the surface of the drum 100-2 with charges of P Coulombs.

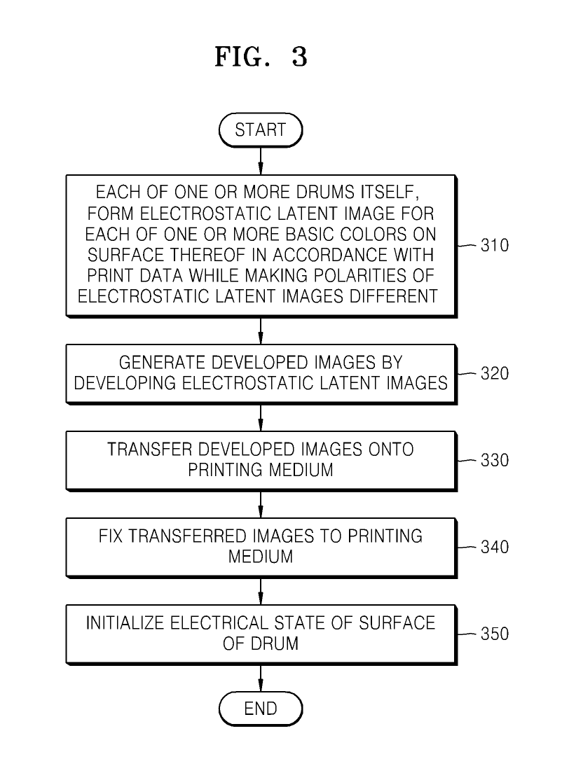

FIG. 3 is a flowchart of an image forming method according to an exemplary embodiment of the present invention performed in the image forming apparatus illustrated in FIGS. 1A and 1B. The image forming method may include operations 310 through 350 for rapidly completing color printing by using a minimal number of drums without charging the entire surface of a drum with charges of a certain polarity and without exposing the drum surface.

In operation 310, the drum 100-n itself forms an electrostatic latent image for each of one or more basic colors on the surface thereof by considering print data that the image forming apparatus desires to print.

After operation 310, in operation 320, the developing unit 120 develops the electrostatic latent images formed in operation 310 to thereby generate developed images.

After operation 320, in operation 330, the transfer unit 130 transfers the developed images to the printing medium.

After operation 330, in operation 340, the fixing unit 140 fixes the developed images onto the printing medium.

After operation 330 or 340, in operation 350, the cleaning unit 150 initializes the electrical state of the surface of the drum 100-n.

The operations 310 through 350 are repeated for each of the drums 100-1 through 100-N.

As described above, in an image forming apparatus and an image forming method according to exemplary embodiments of the present invention, a drum itself forms an electrostatic latent image on the surface thereof in contrast to the conventional art in which an electrostatic latent image corresponding to print data is formed on the surface of a drum by uniformly charging the entire drum surface with charges of a certain polarity and exposing the drum surface. Therefore, the time required to print the print data is drastically reduced.

In addition, in contrast to a conventional image forming apparatus, in the image forming apparatus and the image forming method according to exemplary embodiments of the present invention, electrostatic latent images for a plurality of basic colors are differently developed according to the basic colors even when the electrostatic latent images are altogether formed on the surface of a single drum, so that developing, transferring, and fixing operations for the plurality of basic colors are performed altogether. Thus, the time required to perform color printing is more securely reduced.

Moreover, the image forming apparatus includes no devices for uniformly charging the entire drum surface with charges of a certain polarity and no devices for exposing the drum surface, thereby increasing the product competitiveness through miniaturization.

Also, in the image forming apparatus and the image forming method according to exemplary embodiments of the present invention, developing, transferring, and fixing operations for the plurality of basic colors are performed altogether using a single drum. Accordingly, a smaller number of drums than the number of basic colors for use in representing colors to be printed are required in contrast to a conventional image forming apparatus which is required to include a number of drums as many as the number of basic colors for use in representing colors to be printed. Therefore, the product competitiveness can be more securely increased through miniaturization.

As such, in the image forming apparatus and the image forming method according to exemplary embodiments of the present invention, a small number of drums are required even when a large number of basic colors are used to represent colors to be printed. Therefore, the manufacturing costs for the image forming apparatus are reduced compared to a conventional image forming apparatus which is required to include a number of drums as many as the number of basic colors for use in representing colors to be printed, and thus the price competitiveness of the image forming apparatus is increased.

In a conventional image forming method where the uniform charging of the entire drum surface with charges of a certain polarity and the exposure of the drum surface are necessarily performed to print data, if at least one of the uniform charging and the exposure is performed incorrectly, high quality print outs cannot be expected. However, in the image forming method according to exemplary embodiments of the present invention, neither of these operations are required, resulting in high quality print outs.

Moreover, in the image forming apparatus and the image forming method according to exemplary embodiments of the present invention, the polarity of the surface of the drum is changed to easily detach a developed image from the drum surface upon transfer of the developed image onto a printing medium, so that the developed image is more easily transferred onto the printing medium than in the conventional art. Similarly, when new print data is given, developer remainders can be clearly and easily removed from the drum surface before printing the print data, by changing the polarity of the drum surface.

The exemplary embodiments of the present invention can be written as computer programs and can be implemented in general-use digital computers that execute the programs using a computer readable recording medium. Examples of the computer readable recording medium include magnetic storage media (e.g., ROM, floppy disks, hard disks, etc.), and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An image forming apparatus which represents color of print data to be printed by using at least one basic color, the image forming apparatus comprising:
a drum that forms an electrostatic latent image for each of one or more of the at least one basic color on a surface of the drum in accordance with the print data, wherein if there are two electrostatic latent images, then each of the electrostatic latent images formed on the drum has a different polarity;
a developing unit which develops the electrostatic latent images so as to generate developed images;
a transfer unit which transfers the developed images onto a printing medium; and
a fixing unit which fixes the transferred images to the printing medium.

2. The image forming apparatus of claim 1, wherein the drum forms the electrostatic latent image for each of one or more of the at least one basic color by, according to the print data, charging a plurality of cells which constitute a circumferential layer of the drum.

3. The image forming apparatus of claim 2, wherein the drum forms the electrostatic latent image for each of one or more of the at least one basic color by, in consideration of the print data, charging plates of capacitors of the plurality of cells, which plates form part of the surface of the drum.

4. The image forming apparatus of claim 3, wherein the capacitors of the cells are separated from each other.

5. The image forming apparatus of claim 2, wherein the circumferential layer of the drum consists essentially of the cells.

6. The image forming apparatus of claim 1, wherein the developing unit deposits a developer on the drum to form the developed image; and
wherein a portion of the surface of the drum on which the developed image is located is charged with the same polarity as the polarity of the developer, and in this state, the developed image is transferred onto the printing medium.

7. The image forming apparatus of claim 1, further comprising a cleaning unit which electrically initializes the surface of the drum after an operation of the transfer unit has been completed.

8. The image forming apparatus of claim 1, wherein the drum operates in consideration of at least one of a printing resolution set for the print data and a size of the printing medium.

9. The image forming apparatus of claim 1, wherein the drum is one of a belt drum and a cylindrical drum.

10. The image forming apparatus of claim 1, further comprising one or more additional drums having the properties of the drum of claim 1.

11. The image forming apparatus of claim 1,
wherein the at least one basic color is a plurality of basic colors; and
wherein the drum forms an electrostatic latent image for more than one of the plurality of basic colors.

12. An image forming method performed in an image forming apparatus that represents color of print data to be printed by using at least one basic color and comprises a drum, the method comprising:
forming an electrostatic latent image for each of one or more of the at least one basic color, in accordance with the print data, on a surface of the drum wherein if there are 2 electrostatic latent images, then each of the electrostatic latent images on the drum has a different polarity;
developing the electrostatic latent images so as to generate developed images;
transferring the developed images onto a printing medium; and
fixing the transferred images to the printing medium, wherein the drum forms the electrostatic latent images.

13. The image forming method of claim 12, wherein in the forming of the electrostatic latent image for each of one or more of the at least one basic color, the electrostatic latent image is formed by, according to the print data, charging a plurality of cells which constitute a circumferential layer of the drum.

14. The image forming method of claim 13, wherein in the forming of the electrostatic latent image, the electrostatic latent image is formed by, in consideration of the print data, charging plates of capacitors of the plurality of cells forming part of the circumferential layer.

15. The image forming method of claim 14, wherein the capacitors of the cells are separated from each other.

16. The image forming method of claim 13, wherein the circumferential layer of the drum consists essentially of the cells.

17. The image forming method of claim 12, wherein in the transferring of the developed images, a portion of the surface of the drum on which the developed image is located is charged with the same polarity as the polarity of developer forming the developed image, and in this state, the developed image is transferred onto the printing medium.

18. The image forming method of claim 12, further comprising electrically initializing a portion of the surface of the drum on which the transferring of the developed images has been completed.

19. The image forming method of claim 12, wherein the forming of the electrostatic latent image is performed in consideration of at least one of a printing resolution set for the print data and a size of the printing medium.

20. The image forming method of claim 12, wherein the drum is one of a belt drum and a cylindrical drum.

21. A computer readable medium encoded with a computer program for the method of claim 12.

22. The image forming method of claim 12, wherein the image forming apparatus comprises a plurality of drums, and
wherein each of the plurality of drums performs the forming an electrostatic latent image for each of one or more of the at least one basic color.

23. A drum for use in an image forming apparatus which represents color of print data to be printed by using at least one basic color, the drum comprising:
a circumferential layer which forms an electrostatic latent image for each of one or more of the at least one basic color on a surface of the drum in accordance with the print data;
wherein if there are 2 electrostatic latent images, then each of the electrostatic latent images formed on the surface of the drum has a different polarity.

24. A method for preparing a drum in an image forming apparatus to create an image from print data by using at least one basic color, the method comprising:
forming an electrostatic latent image for each of the at least one basic color, in accordance with the print data, on a surface of the drum;
wherein if there are 2 electrostatic latent images, then each of the electrostatic latent images on the drum has a different polarity.

25. An image forming apparatus which represents color of print data to be printed by a plurality of basic colors, the image forming apparatus comprising at least one drum, wherein the at least one drum deposits images for more than one of the plurality of basic colors on a printing medium in a single pass of the at least one drum over the print medium.

26. The image forming apparatus of claim 1, wherein the drum forms an electrostatic latent image for each of two basic colors of the one or more of the at least one basic color.
